(19) United States
(12) Patent Application Publication
(10) Pub. No.: US 2014/0316024 A1
(43) Pub. Date: Oct. 23, 2014

(54) COUPLED FLY ASH FILLED POLYMER COMPOUNDS

(71) Applicant: PolyOne Corporation, Avon Lake, OH (US)

(72) Inventors: Maziyar Bolourchi, Avon, OH (US); Roger W. Avakian, Solon, OH (US)

(21) Appl. No.: 14/359,536

(22) PCT Filed: Nov. 27, 2012
(86) PCT No.: PCT/US2012/066679

§ 371 Date: May 20, 2014

Related U.S. Application Data
(60) Provisional application No. 61/564,561, filed on Nov. 29, 2011.

(51) Int. Cl. C08F 10/02; C08K 5/101; C08L 23/06; C08K 3/34

(52) U.S. Cl. CPC C08F 10/02; C08K 3/34; C08K 5/101; C08L 23/06
USPC 521/143; 525/333.7; 523/122; 524/449; 524/318; 524/585

(57) ABSTRACT

Thermoplastic compounds are disclosed having functional filler of fly ash particles coupled to the thermoplastic resin via a coupling agent. A coupling agent of functional silane grafts on a backbone of the same polymer or a compatible polymer as the thermoplastic resin causes interaction of the fly ash particles with the thermoplastic resin to enhance physical properties, particularly Notched Izod impact resistance at room temperature and at −40° C. The coupling interface between the fly ash particle and the coupling agent and the thermoplastic resin is so strong that there can be cohesive failure of the fly ash particle before there is adhesive failure of the fly ash particle from the coupling agent in the thermoplastic resin.

### CLAIM OF PRIORITY

This application claims priority from U.S. Provisional Patent Application Ser. No. 61/564,561 bearing Attorney Docket Number 12011023 and filed on Nov. 29, 2011, which is incorporated by reference.

### FIELD OF THE INVENTION

This invention relates to thermoplastic compounds having functional filler of fly ash particles coupled to the thermoplastic resin.

### BACKGROUND OF THE INVENTION

Fly ash and cinders are by-products of combustion. Fly ash and cinders can be separated into specific particle sizes. Revolutionary Plastics, LLC is a supplier of fly ash and cinders having specific particles sizes and the owner of U.S. Pat. No. 7,879,939 (Prince et al.), which is incorporated by reference as if fully rewritten herein.

Prince et al. discloses preparation of fully formulated thermoplastic compounds, such as identified in Table 1, in which the fly ash and/or cinders component constitutes 1-40 weight percent of the compound for a foamed article and in which the fly ash and/or cinders component can constitute 1-70 weight percent of the compound for an un-foamed article.

It has been found that use of fly ash can reduce cycle time of molding operations or can increase throughput of extrusion operations, thereby reducing production costs in both instances. However, as seen in FIG. 1, a photomicrograph at 5000× magnification of Comparative Example C identified below, particles of fly ash, nearly spherical in shape, are dissociated from adjacent sockets of thermoplastic resin in which they reside. The dissociation affects physical properties of the resulting thermoplastic compounds shaped by that molding or extrusion operation.

### SUMMARY OF THE INVENTION

What is needed is a functional filler for polymer compounds that reduces cycle time of molding operations and reduces unit production costs but maintains or improves the physical properties of the unfilled plastic compound.

The present invention solves these problems by employing a coupling agent which interacts with both the thermoplastic resin and the fly ash particles serving as the functional filler.

One aspect of the invention is a thermoplastic compound, comprising (a) a thermoplastic resin, (b) particles of fly ash, and (c) a coupling agent compatible with the thermoplastic resin comprising a grafted polymer having functional silane grafts on a backbone of a polymer same as the thermoplastic resin or a polymer compatible with the thermoplastic resin, wherein the fly ash is coupled to the coupling agent.

Another aspect of the invention is a molded, extruded, or calendered article from the coupled fly ash filled thermoplastic compound identified in the paragraph above.

The following embodiments explain some attributes of the invention with reference to the following Drawing.

### BRIEF DESCRIPTION OF THE DRAWING

FIG. 1 is a photomicrograph at 5000 magnification which shows dissociation of fly ash particles in the thermoplastic resin.

FIG. 2 is a photomicrograph at 5000 magnification which shows tendon association of fly ash particles with the thermoplastic resin.

FIG. 3 is a photomicrograph at 5000 magnification which shows substantially continuous coupling of a fly ash particle with the thermoplastic resin.

FIG. 4 is a photomicrograph at 500 magnification which shows substantially continuous coupling of multiple fly ash particles with the thermoplastic resin.

FIG. 5 is a photomicrograph at 7000 magnification which shows cohesive failure of a fly ash particle before adhesive failure of that fly ash particle coupled to the thermoplastic resin.

### EMBODIMENTS OF THE INVENTION

### Thermoplastic Resins for Polymer Compounds

Any thermoplastic resin is a candidate for use with fly ash particles according of the invention, to be selected for its rheological properties and suitability for grafting reactions. Non-limiting examples of large volume commercial thermoplastic resins include polyolefins, polyamides, polyesters, poly(meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, and copolymers of any of them and combinations of any two or more of them.

Published literature exists to identify many commercial species of these categories of thermoplastic resins. Non-limiting examples of specific commercial thermoplastic resins include acrylonitrile butadiene styrene (ABS), polymethyl methacrylate (PMMA), cellulose acetate, cyclic olefin copolymer (COC), ethylene-vinyl acetate (EVA), ethylene vinyl alcohol (EVOH), polytetrafluoroethane (PTFE), ionomers, polyoxymethylene (POM or Acetal), polyacrylonitrile (PAN), polyamide 6, polyamide 6,6, polyamide-imide (PAI), polyaryletherketone (PAEK), polybutadiene (PBD), polybutylene (PB), polybutylene terephthalate (PBT), polycaprolactone (PCL), polychlorotrifluoroethylene (PCTFE), polyethylene terephthalate (PET), polycyclohexylene dimethylene terephthalate (PCT), polycarbonate (PC), polyhydroxybutyrate (PHB), polyethylene (PE), polyetheretherketone (PEEK), polyetherketoneketone (PEKK), polyetherimide (PEI), polyethersulfone (PES), chlorinated polyethylene (CPE), polyimide (PI), polylactic acid (PLA), polymethylpentene (PMP), polyphenylene ether (PPE), polyphenylene sulfide (PPS), polyphthalamide (PPA), polypropylene (PP), polysulfone (PSU), polytrimethylene terephthalate (PTT), polyurethane (PU), polyvinyl acetate (PVA), polyvinyl chloride (PVC), polyvinylidene chloride (PVDC), and styrene-acrylonitrile (SAN).

These specific thermoplastic resins can be substituted or unsubstituted and mixed in any combination suitable to any person having ordinary skill in the art.

The quality of the thermoplastic resin can be prime or reprocessed via recycling. The use of recycled thermoplastic resin further can reduce costs for the manufacturer and provides additional sustainable solutions for the environment.

Functional Filler

Fly ash or fly ash and cinders are by-products of coal combustion and have been found in this invention to be an unexpectedly valuable filler to perform the function of reducing of molding cycle times without loss of physical properties. Fly ash particles useful in this invention are registered as CAS No. 71243-67-9.

Stated most generally, fly ash constitutes a multiplicity of spheres of a mineral composite formed during coal combustion. Stated most generally, cinders are other residue particulates formed during coal combustion, such as fused or vitrified matter. Preferred grades of fly ash particles have been processed to result in the following properties: a melting point or greater than about 1090° C.; a specific gravity of from about 2.2 to about 2.8; less than 100 parts per million of lead, hexavalent chromium, mercury or cadmium, a moisture content of 1% or less; a polycyclic aromatic hydrocarbon content of less than about 200 parts per million; a crystalline silica content of below about 0.5%; and a particle size range in which about 85% of the particles fall within 0.2 μm-280 μm, and remainder are less than about 850 μm.

Fly ash or fly ash and cinders preferably can be treated according to the procedures identified in US Patent Application Publication 2011/0071252, which disclosure is incorporated by reference herein. Fly ash, with and without cinders, can be mechanically treated and blended or otherwise mixed to form a filler or blend of fillers that is useful when introduced into molten thermoplastic compositions as disclosed in U.S. Pat. No. 7,879,939 (Prince et al.).

Fly ash or fly ash and cinders of a variety of grades and treatments can be purchased from Revolutionary Plastics LLC of Las Vegas, Nev. or its distributor, PolyOne Corporation of Avon Lake, Ohio. The fly ash or fly ash and cinders can be mixed into a masterbatch for convenient sale in a thermoplastic carrier. Two of such grades are Eclipse™ LLH7506 masterbatch in which about 85% of the particles fall within 0.2 μm-280 μm, and the remainder are less than about 850 μm and Eclipse™ LLH187506 masterbatch in which 100% of the particles fall within 0.2 μm-180 μm.

Coupling Agent

The present invention has found that only certain types of coupling agents are suitable for use with the functional filler and the thermoplastic resin. Conventional coupling agents for thermoplastic resins, such as maleated polyolefins (also called maleic anhydride grafted polyolefins) and ethylene maleic anhydride copolymers are unsuitable because they do not appreciably improve physical properties, such as Impact Resistance, also called Notched Izod, either at room temperature (RT) or −40° C.

Unexpectedly, the invention benefits from a coupling agent which is a grafted copolymer, in which each graft is a functional group and the resin is the same resin as used for the thermoplastic resin in the compound or compatible with the thermoplastic resin in the compound. Preferably, the grafted copolymer can be a grafted olefinic copolymer, such as an alpha-olefin copolymer or an olefin homopolymer. More specifically, the alpha-olefin copolymer can be an ethylene-butene copolymer, more properly known as poly(ethylene-co-1-butene). Alternatively, the grafted olefin polymer can be a grafted ethylene polymer.

Without being limited to a particular theory, it is believed that the grafts on the coupling agent covalently react with the surface chemistry of the fly ash particles.

Preferably, any conventional polyolefin can be used as the thermoplastic resin. Non-limiting examples of polyolefins include polyethylenes, ethylene copolymers, and combinations thereof. Of the available candidates, a polyethylene is preferred as the resin for grafting. Commercially available polyethylene resins include HD 6908.19 from ExxonMobil™; Sclair® 31E from Nova Chemicals; EM811 from Westlake Chemical, and Tafmer™ brand ethylene butylene copolymer resins from Mitsui.

Melt Flow Indices of polymer resins and or polymer resin blends can range from about 1 to about 75 and preferably from about 10 to about 40 g/10 min. Melt Flow Indices of grafted resins can range from about 1 to about 20 and preferably from about 5 to about 10.

Most preferably, the resin for grafting is an ethylene-butene copolymer having a Melt Flow Index of about 3.6 g/10 min. and a brittleness temperature of −70° C. Commercially, that copolymer is available as Tafmer™ DF840 brand ethylene butylene copolymer resins from Mitsui.

Grafting requires both a free radical initiator and a functional chemical, such as and preferably a polyfunctional unsaturated organosilane. Any conventional initiator for polyolefins and any conventional unsaturated organosilane are candidates for use in the invention. Particularly preferred are free radical initiators such as peroxides, and particularly, dicumyl peroxide (DCP). Particularly preferred organosilanes are vinytrimethoxy silane (VTMS) and or vinyltriethoxy silane (VTES). Commercially available VTMS is sold by Momentive Chemicals under the Silquest brand, with Silquest A-171 being currently preferred.

Grafting can occur in an extruder with the ingredients introduced at the head of the extruder operating at temperatures sufficient to melt the polymer resins and initiate the grafting reaction. Pellets of the grafted polyolefin resin can be formed for later compounding with the other ingredients of the compound. Preferably, the DCP is dissolved in the VTMS and then blended together with the ethylene-butene copolymer and extruded at 250-300 rpm at a temperature ranging from about 180-190° C. Less than two weight percent of VTMS and less than one weight percent of DCP in at least 97 weight percent of ethylene-butene copolymer is sufficient to produce a highly reactive silane-grafted alpha olefin copolymer suitable as the coupling agent of this invention.

Alternatively to synthesis of a silane grafted ethylene-butene copolymer, one can employ a silane-grafted alpha olefin copolymer sold by PolyOne Corporation as Syncure™ S1054A Silane Grafted Polyethylene as the coupling agent.

Optional Additives

The compound of the present invention can include conventional plastics additives in an amount that is sufficient to obtain a desired processing or performance property for the final molded, extruded, or calendered compound. The amount of additive(s) should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Table 1 shows acceptable, desirable, and preferred ranges of the ingredients of the compound. The compound can comprise, consist essentially of, or consist of these ingredients.

TABLE 1

| Ingredient (Wt. %) | Acceptable | Desirable | Preferred |
|---|---|---|---|
| Thermoplastic | 40-70 | 45-65 | 50-60 |
| Resin | | | |
| Fly Ash | 15-25 | 16-24 | 17-23 |
| Masterbatch | | | |
| Coupling Agent | 10-40 | 15-35 | 25-30 |
| Other Additives | 0-20 | 0-15 | 0-10 |

Compound Processing

One can form the compound using continuous or batch techniques, using extruders or mixers, respectively. Mixing in a continuous process typically occurs in an extruder that is elevated to a temperature that is sufficient to melt the polymer matrix with addition either at the head of the extruder or downstream in the extruder of the solid ingredient additives. Extruder speeds can range from about 50 to about 500 revolutions per minute (rpm), and preferably from about 100 to about 300 rpm. Typically, the output from the extruder is pelletized for later extrusion or molding into polymeric articles.

The preparation of compounded pellets of fully let-down compound is explained in U.S. Pat. No. 7,879,939 (Prince et al.).

Subsequent Processing

Final article processing involves reshaping by extrusion, molding, or calendering, followed by natural or accelerated cooling to form the final plastic article desired.

In the case of molding, particularly injection molding, the reshaping step includes pressurized injecting, holding, and cooling steps before the plastic article is ejected, the cycle of which the time is being measured to determine cycle time. More specifically, the reshaping step comprises four substeps of (1) injecting the compound into a mold; (2) holding the compound in the mold to form the plastic article in the shape of the mold; (3) cooling the plastic article to permit the plastic article to be released from the mold while retaining shape of the mold; and (4) ejecting the plastic article. The time between commencement of the injecting substep (1) and commencement of the ejecting substep (4) is one cycle time, and the cycle time of the compound is reduced from about 5 percent to about 30 percent for a plastic article of the compound as compared with a cycle time between commencement of substep (1) and commencement substep (4) for a plastic article that only contains the plastic resin without the functional filler present.

The desire for reduction of cycle time may need to be balanced the desire for a particular surface appearance of the final plastic article.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using compounds of the present invention.

### USEFULNESS OF THE INVENTION

Compounds of the present invention can be molded, extruded, or calendered with surprising efficiency and result in plastic articles having excellent physical properties and appearance.

It is possible that molding cycle times can be reduced by from about 5 percent to about 30 percent and preferably at least about 14 percent merely because of the presence of the fly ash particles as functional fillers, all other factors being equal.

With the cost of the fly ash or fly ash and cinders possibly being less than the cost of the plastic resin being replaced, less expensive molded, extruded, or calendered plastic articles can be made, without unacceptable loss of physical properties or sacrifice of ultimate surface appearance.

As seen in FIGS. 1-3, the selection of the coupling agent used in the invention is significant. As stated above, FIG. 1, a photomicrograph at 5000× magnification of Comparative Example C shows the situation when no coupling agent is used. Particles of fly ash, nearly spherical in shape, are dissociated from adjacent sockets of thermoplastic resin in which they reside. The dissociation affects physical properties of the resulting thermoplastic compounds shaped by that molding or extrusion operation, as demonstrated in the Examples below.

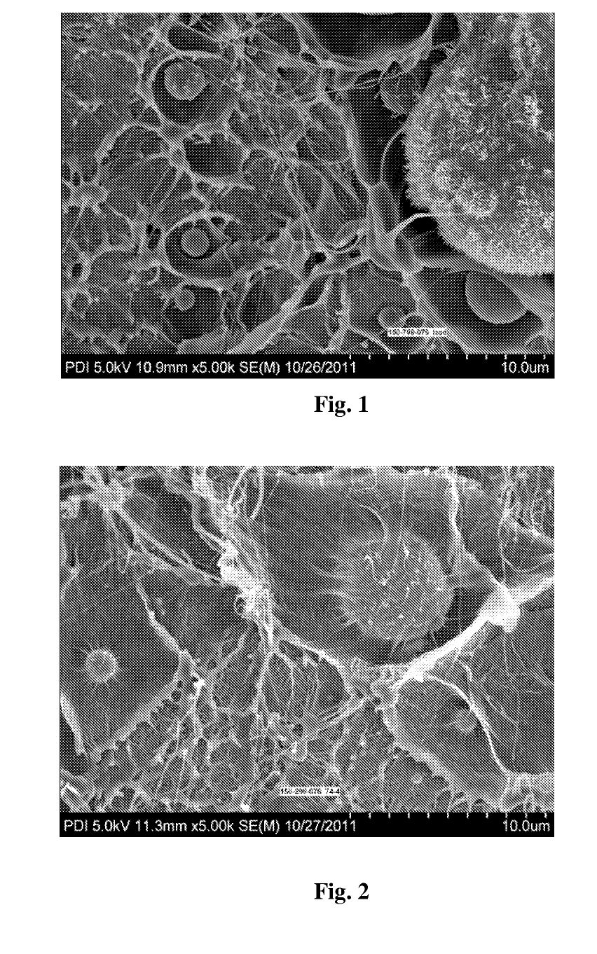

FIG. 2, a photomicrograph at 5000× magnification of Comparative Example D shows the situation when maleated polyolefin coupling agent is used. The particles of fly ash still reside in larger thermoplastic resin sockets but are partially connected with tendons of coupling agent as bone would be connected to muscle. This tendon association is an improvement over dissociation as seen in FIG. 1 but is nonetheless inadequate, as demonstrated in the physical properties of Comparative Example D seen below.

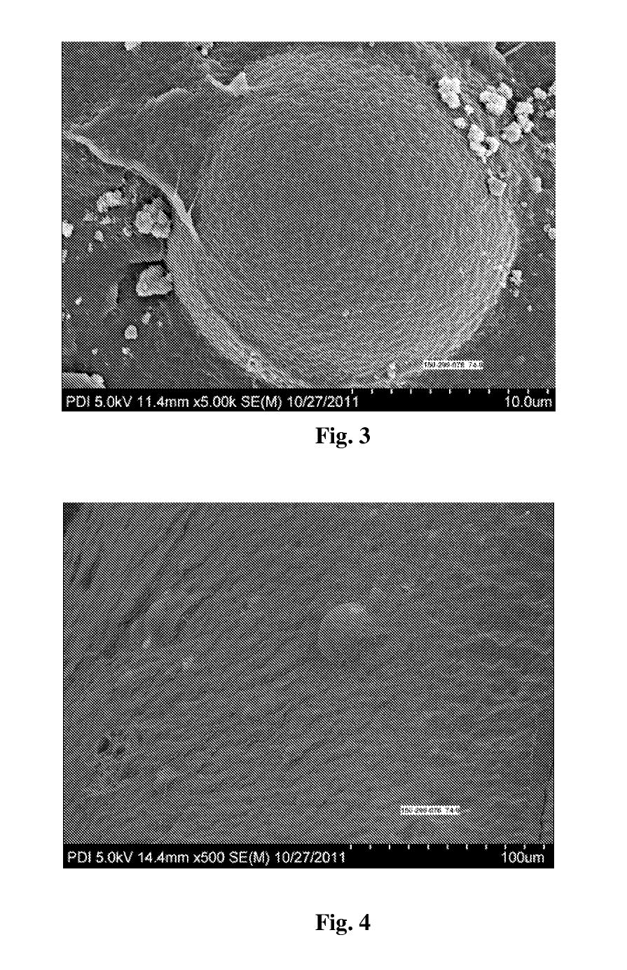

The compound of Example 1 is seen in FIG. 3, a photomicrograph at 5000× magnification, and FIG. 4, a photomicrograph at 500× magnification. The compound of Example 1 exhibits a totally different interaction of fly ash particles to the thermoplastic resin. Not only are all of the sockets of resin gone, as compared with FIGS. 1 and 2, but the fly ash particles are substantially coated and compatibilized with the dissimilar thermoplastic resin, because of the use of a coupling agent which has affinity for both the ceramic fly ash particles and the organic thermoplastic resin. In the preferred use of silane grafted alpha olefin copolymer, of which Example 1 is one embodiment, without being limited to a particular theory, it is believed that the VTMS covalently reacts with the polyolefin backbone via the unsaturated functionality. It is also believed that the silane functionality of a graft reacts covalently with a surface of the fly ash particle while the alpha olefin copolymer backbone, coupled to the silane via that unsaturated functionality, blends intimately with the polyethylene thermoplastic resin such that the polymer chains of the coupling agent become intertwined and physically secured with the polymer chains of the thermoplastic resin. Coupling is achieved with dramatic visual and performance results, allowing the compounds of the invention to be used in a wide variety of end use articles.

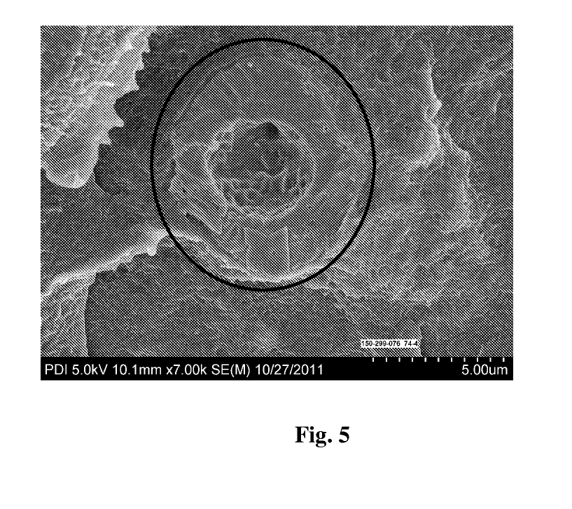

FIG. 5, a 7000 magnification photomicrograph of Comparative Example D, is even more demonstrative of the coupling of the ceramic fly ash particle to the organic thermoplastic resin. The shearing of a test sample of Comparative Example D resulted in the fracturing of a fly ash particle which can be seen just within the circle superimposed on the photomicrograph. The fly ash particle itself is hollow. The coupling interface between fly ash particle and the thermoplastic resin is so strong that there was cohesive failure of the fly ash particle before there was adhesive failure of the fly ash particle from the thermoplastic resin. The bond between particle and resin was stronger that the particle itself. For Comparative Example D, which has a Notched Izod impact resistance of 1.3, greater than the Notched Izod impact resistance of 0.9 for Comparative Example C, this FIG. 5 demonstrates that adhesive strength between the fly ash particles and the coupling agent is greater than cohesive strength of the fly ash particles themselves. It is believed that Examples 1-7 with a Notched Izod impact resistance considerably greater than 1.3 should all have adhesive strength between the fly ash particles and the coupling agent greater than cohesive strength of the fly ash particles themselves.

Any number of plastic articles can be benefit from the use of fly ash particles in the preparation of the polymer compound. Non-limiting examples of final plastic articles which can benefit from the invention include appliances (refrigerators, freezers, washers, dryers, toasters, blenders, vacuum cleaners, coffee makers, mixers); building and construction articles (fences, decks and rails, floors, floor covering, pipes and fittings, siding, trim, windows, window shutters, doors, molding, plumbing products, toilet seats, and wall coverings); consumer goods (power hand tools, rakes, shovels, lawn mowers, shoes, boots, golf clubs, fishing poles, and watercraft); electrical/electronic (printers, computer housings, business equipment, LCD projectors, mobile phones, connectors, chip trays, circuit breakers, and plugs); healthcare products (wheelchairs, beds, testing equipment, and packaging); industrial products (containers, bottles, drums, material handling, gears, bearings, gaskets and seals, valves, wind turbines, and safety equipment); packaging (food and beverage, cosmetic, detergents and cleaners, personal care, pharmaceutical and wellness); and transportation articles (automotive aftermarket parts, bumpers, window seals, instrument panels, consoles, under hood electrical, and engine covers).

### EXAMPLES

For the ingredients Grafted Tafmer DF 840/DF 8200 Coupling Agent and Grafted Tafmer DF 840 Coupling Agent, Table 2 shows the respective recipes. Tables 3-5 show the ingredients used in the Examples and Comparative Examples, the recipes, and results.

TABLE 2
Grafted Resin (Wt. %)

| | | |
|---|---|---|
| Tafmer DF 8200 | 73.62 | 0 |
| Tafmer DF 840 | 24.53 | 98.15 |
| Dicumyl Peroxide | 0.50 | 0.50 |
| Silquest A-171 VTMS | 1.35 | 1.35 |
| Total | 100.00 | 100.00 |

The dicumyl peroxide was first dissolved in the VTMS and then that combination was blended with the alpha olefin copolymer(s). Then, a 16 mm Prism counter-rotating twin screw extruder having a L:D ratio of 40:1 was used to make the grafted resins shown in Table 3. Temperature was 190° C. in all zones and die. The RPM was 175 for the first grafted resin and 250-300 for the second; the die pressure was 33 bar; the feeder rate was 12%; the vacuum was 19 inches Hg; and the percent torque ranged from 72-80%. The grafted resin was pelletized for later compounding.

The grafted resin along with other ingredients for the recipes in Table 3 were melt-mixed using the same extruder operating at 195-215° C. in all zones and die and at 500 RPM and a percent torque ranging from 75-95%. The die pressure was between 20 and 50 bar; the feeder rate was between 15-30%. The extrudate was pelletized for later use.

The extrudate of each Example and Comparative Example, including the controls, was molded into plaques, bars, discs and other shapes required by the ASTM requirements, using a 120 Ton Demag Injection molding machine. The process parameters include barrels temperatures ranging between 410-420° F., mold temperature of 100° F. and a 50 psi back pressure, with a screw RPM of 100, and injection velocity of 1.0 in/sec.

The various molded shapes were then tested. The results were reported in Tables 3-5 with standard deviations.

TABLE 3

| Material (Wt. %) | A | B | C | D | E | F | G | H | 1 |
|---|---|---|---|---|---|---|---|---|---|
| LLH 7506 Fly Ash MB; | | | 20.00 | 20.00 | 20.00 | 20.00 | 20.00 | 20.00 | 20.00 |
| Revolutionary Plastics | | | | | | | | | |
| Exxon 6605.70 HD HDPE; | 100.00 | | 80.00 | 75.00 | 75.00 | | | | 40.00 |
| ExxonMobil | | | | | | | | | |
| Chevron 9708 HDPE; Chevron | | 100.00 | | | | 80.00 | 75.00 | 75.00 | |
| PolyBond 3009 Maleic Anhydride | | | | 5.00 | | | 5.00 | | |
| Modified High Density | | | | | | | | | |
| Polyethylene Coupling Agent; | | | | | | | | | |
| Chemtura | | | | | | | | | |
| FusaBond E528 Anhydride | | | | | 5.00 | | | 5.00 | |
| Modified Polyethylene Coupling | | | | | | | | | |
| Agent; DuPont | | | | | | | | | |
| Grafted Tafmer DF 840/D 8200 | | | | | | | | | 40.00 |
| Coupling Agent | | | | | | | | | |
| TOTAL | 100.00 | 100.00 | 100.00 | 100.00 | 100.00 | 100.00 | 100.00 | 100.00 | 100.00 |
| Test | | | | | | | | | |
| Gardner Impact RT (in. lb./mil.) | 1.68 | 1.72 | 0.85 | 0.99 | 1.33 | 0.85 | 0.98 | 1.15 | 2.07 |
| ASTM D-5420 | | | | | | | | | |
| Gardner Impact STDEV | 0.023 | 0.023 | 0.775 | 0.168 | 0.027 | 0.0827 | 0.023 | 0.775 | 0.737 |
| Notched Izod RT (ft-lb/in) | 2.5 | 1.2 | 0.9 | 1.3 | 1.8 | 0.6 | 0.8 | 0.9 | 9.3 |
| ASTM D-256 | | | | | | | | | |
| Notched Izod RT STDEV | 0.2 | 0.1 | 0.1 | 0.1 | 0.1 | 0 | 0 | 0 | 0.2 |
| Flex Mod (kpsi) | 99.8 | 137 | 104 | 114 | 103 | 154 | 148 | 146 | 33.5 |
| ASTM D-790 | | | | | | | | | |
| Flex Mod STDEV | 3.3 | 2.2 | 1.7 | 2.1 | 1.4 | 2 | 5.6 | 4.5 | 2.8 |
| Flex Strength (psi) | 3400 | 4260 | 3270 | 3610 | 3370 | 4120 | 4180 | 4170 | 1460 |
| ASTM D-790 | | | | | | | | | |
| Flex Strength STDEV | 14 | 30 | 372 | 25 | 19 | 31 | 27 | 31 | 16 |
| Tensile Modulus (kpsi) | 152 | 222 | 180 | 189 | 172 | 243 | 196 | 198 | 37 |
| ASTM-D638 | | | | | | | | | |
| Tensile Modulus STDEV | 6 | 8 | 5 | 18 | 4 | 6 | 12 | 5 | 18 |
| Tensile Strength (psi) | 2060 | 2090 | 1960 | 2150 | 2030 | 1980 | 2010 | 1975 | 1750 |
| ASTM-D638 | | | | | | | | | |
| Tensile Strength STDEV | 46 | 48 | 27 | 161 | 16 | 14 | 27 | 76 | 46 |
| Tensile Elongation (%) | 300 | 350 | 370 | 350 | 310 | 300 | 290 | 300 | 300 |
| ASTM-D638 | | | | | | | | | |
| Tensile Elongation STDEV | 8 | 70 | 68 | 55 | 14 | 9 | 25 | 10 | 9 |

TABLE 4

| Material (Wt. %) | I | J | K | L | M | N | 2 | O | P | Q |
|---|---|---|---|---|---|---|---|---|---|---|
| LLH 187506 Fly Ash MB; | 20.00 | 20.00 | 20.00 | 20.00 | 20.00 | 20.00 | 20.00 | 20.00 | 20.00 | 20.00 |
| Revolutionary Plastics | | | | | | | | | | |
| Exxon 6605.70 HD HDPE; | 80.00 | 75.00 | 75.00 | | | | 40.00 | 77.00 | | 77.00 |
| ExxonMobil | | | | | | | | | | |
| Chevron 9708 HDPE; Chevron | | | | 80.00 | 75.00 | 75.00 | | | 77.00 | |
| PolyBond 3009 Maleic | | 5.00 | | | 5.00 | | | | | |
| Anhydride Modified High | | | | | | | | | | |
| Density Polyethylene Coupling | | | | | | | | | | |
| Agent; Chemtura | | | | | | | | | | |
| FusaBond E528 Anhydride | | | 5.00 | | | 5.00 | | | | |
| Modified Polyethylene | | | | | | | | | | |
| Coupling Agent; DuPont | | | | | | | | | | |
| Grafted Tafmer DF 840/D | | | | | | | 40.00 | | | |
| 8200 Coupling Agent | | | | | | | | | | |
| ZeMac E400 Ethylene-Maleic | | | | | | | | 3.00 | 3.00 | |
| Anhydride Copolymer | | | | | | | | | | |
| Coupling Agent; Vertellus | | | | | | | | | | |
| ZeMac E60 EMA Ethylene- | | | | | | | | | | 3.00 |
| Maleic Anhydride Copolymer | | | | | | | | | | |
| Coupling Agent; Vertellus | | | | | | | | | | |
| TOTAL | 100.00 | 100.00 | 100.00 | 100.00 | 100.00 | 100.00 | 100.00 | 100.00 | 100.00 | 100.00 |
| Test | | | | | | | | | | |
| Gardner Impact RT | 1.17 | 0.94 | 1.19 | 1.02 | 0.78 | 0.92 | 2.08 | 1.28 | 0.68 | 0.73 |
| (in. lb./mil.) ASTM D-5420 | | | | | | | | | | |
| Gardner Impact STDEV | 0.113 | 0.266 | 0.18 | 0.233 | 0.027 | 0.136 | 0.0033 | 0.427 | 0.023 | 0.071 |
| Notched Izod RT (ft-lb/in) | 0.9 | 1.3 | 1.8 | 0.6 | 0.7 | 0.9 | 10 | 0.9 | 0.7 | 0.9 |
| ASTM D-256 | | | | | | | | | | |
| Notched Izod RT STDEV | 0 | 0.1 | 0.2 | 0 | 0 | 0.1 | 0.5 | 0.1 | 0 | 0.1 |
| Flex Mod (kpsi) ASTM D-790 | 114 | 120 | 106 | 154 | 155 | 142 | 39.6 | 121 | 172 | 112 |
| Flex Mod STDEV | 2.5 | 9.1 | 1.6 | 2.5 | 2.8 | 2.6 | 3.4 | 7.2 | 11.1 | 3.2 |
| Flex Strength (psi) ASTM D- | 3430 | 3620 | 3430 | 4080 | 4410 | 4150 | 1570 | 3430 | 4090 | 3420 |
| 790 | | | | | | | | | | |
| Flex Strength STDEV | 43 | 46 | 16 | 40 | 20 | 59 | 40 | 66 | 46 | 33 |
| Tensile Modulus (kpsi) | 152 | 148 | 137 | 209 | 216 | 207 | 42 | 154 | 224 | 145 |
| ASTM-D638 | | | | | | | | | | |
| Tensile Modulus STDEV | 26 | 10 | 4 | 7 | 6 | 6 | 2 | 6 | 7 | 5 |
| Tensile Strength (psi) ASTM- | 1923 | 2000 | 1980 | 1960 | 575 | 1848 | 1760 | 1900 | 1830 | 1870 |
| D638 | | | | | | | | | | |
| Tensile Strength STDEV | 25 | 33 | 45 | 43 | 135 | 295 | 30 | 12 | 164 | 80 |
| Tensile Elongation (%) ASTM- | 300 | 320 | 370 | 320 | 290 | 320 | 300 | 320 | 300 | 335 |
| D638 | | | | | | | | | | |
| Tensile Elongation STDEV | 7 | 50 | 70 | 21 | 30 | 23 | 16 | 26 | 26 | 34 |

TABLE 5

| Material (Wt. %) | R | S | T | 3 | 4 | 5 | 6 | 7 | U | V |
|---|---|---|---|---|---|---|---|---|---|---|
| LLH 187506 Fly Ash MB; | 20.00 | | 20.00 | 20.00 | 20.00 | 20.00 | 20.00 | 20.00 | 20.00 | 20.00 |
| Revolutionary Plastics | | | | | | | | | | |
| Exxon 6605.70 HD HDPE; | | 100.00 | 80.00 | 70.00 | 60.00 | 50.00 | 40.00 | 60.00 | 40.00 | 60.00 |
| ExxonMobil | | | | | | | | | | |
| Chevron 9708 HDPE; | 77.00 | | | | | | | | | |
| Chevron | | | | | | | | | | |
| ZeMac E60 EMA Ethylene- | 3.00 | | | | | | | | | |
| Maleic Anhydride | | | | | | | | | | |
| Copolymer Coupling Agent; | | | | | | | | | | |
| Vertellus | | | | | | | | | | |
| Grafted Tafmer DF 840 | | | | 10.00 | 20.00 | 30.00 | | | | |
| Coupling Agent | | | | | | | | | | |
| Syncure ™ S1054A Silane | | | | | | | 40.00 | 20.00 | | |
| Grafted Polyethylene | | | | | | | | | | |
| Coupling Agent; PolyOne | | | | | | | | | | |
| Tafmer DF 840 Coupling | | | | | | | | | 40.00 | 20.00 |
| Agent; Mitsui | | | | | | | | | | |
| TOTAL | 100.00 | 100.00 | 100.00 | 100.00 | 100.00 | 100.00 | 100.00 | 100.00 | 60.00 | 80.00 |
| Test | | | | | | | | | | |
| Gardner Impact RT | 0.67 | 1.68 | 1.17 | 1.41 | 1.61 | 1.72 | 1.49 | 1.28 | 1.3 | 1.3 |
| (in. lb./mil.) ASTM D-5420 | | | | | | | | | | |
| Gardner Impact STDEV | 0.0289 | 0.02 | 0.13 | 0.11 | 0.05 | 0.02 | 0.02 | 0.16 | 0.11 | 0.02 |
| Gardner Impact −40 C. | | 2.2 | 1.09 | 1.48 | 1.74 | 2.2 | 2.02 | 1.7 | 2.2 | 1.82 |
| (in. lb./mil.) ASTM D-5420 | | | | | | | | | | |
| Gardner Impact STDEV | | 0 | 0.046 | 0.06 | 0.003 | 0 | 0.1 | 0.03 | 0 | 0.02 |
| Notched Izod RT (ft-lb/in) | 0.8 | 2.5 | 0.9 | 4.9 | 11 | 11.2 | 7.5 | 2.3 | 8.7 | 3.4 |
| ASTM _D-256 | | | | | | | | | | |
| Notched Izod RT STDEV | 0.1 | 0.2 | 0.1 | 0.2 | 0.4 | 0.5 | 0.6 | 0.1 | 0.3 | 0.2 |
| Notched Izod −40 C. (ft-lb/in) | | 1.03 | 0.75 | 1.21 | 1.51 | 13.3 | 1.13 | 1.06 | 6.5 | 0.94 |
| ASTM D-256 | | | | | | | | | | |
| Notched Izod −40 C. STDEV | | 0.07 | 0.09 | 0.25 | 0.24 | 3.63 | 0.11 | 0.08 | 2.7 | 0.13 |
| Flex Mod (kpsi) ASTM D- | 162 | 99.8 | 114 | 90 | 67 | 53 | 67 | 86 | 45 | 71 |
| 790 | | | | | | | | | | |
| Flex Mod STDEV | 3.1 | 3.3 | 2.5 | 1 | 5 | 2 | 12 | 6 | 1 | 1 |
| Flex Strength (psi) ASTM D- | 4050 | 3400 | 3430 | 2804 | 2395 | 2003 | 2601 | 3034 | 1807 | 2423 |
| 790 | | | | | | | | | | |
| Flex Strength STDEV | 41 | 14 | 43 | 10 | 6 | 42 | 33 | 12 | 12 | 10 |
| Tensile Modulus (kpsi) | 216 | 152 | 152 | 118 | 79.2 | 57.8 | 89.1 | 124 | 45.7 | 93.2 |
| ASTM D-638 | | | | | | | | | | |
| Tensile Modulus STDEV | 8 | 6 | 26 | 3.6 | 2.5 | 1.7 | 1.2 | 12.2 | 1.7 | 8.8 |
| Tensile Strength (psi) | 1913 | 2060 | 1923 | 1990 | 1930 | 1960 | 1770 | 2030 | 1480 | 1580 |
| ASTM D-638 | | | | | | | | | | |
| Tensile Strength STDEV | 25 | 46 | 25 | 84 | 121 | 173 | 27 | 204 | 176 | 143 |
| Tensile Elongation | 310 | 300 | 300 | 430 | 400 | 380 | 190 | 370 | 410 | 320 |
| (%)ASTM D-638 | | | | | | | | | | |
| Tensile Elongation STDEV | 28 | 8 | 7 | 68 | 100 | 77 | 3 | 60 | 74 | 8 |
| Density (g/cc) ASTM D-792 | | | | 1.038 | 1.030 | 1.027 | 1.031 | 1.048 | 1.016 | 1.029 |
| Density STDEV | | | | 0.003 | 0.003 | 0.000 | 0.001 | 0.010 | 0.003 | 0.000 |

In addition to FIGS. 1-4, the data of Tables 3-5 demonstrated the value of the compounds using the specific coupling agents. Only the two grafted ethylene-butene copolymer resins of the formulations of Table 2 and the commercial Syncure grafted polyethylene performed acceptably. Examples 1-7 share that commonality. These coupling agent candidates all have functional grafts to interact with the fly ash particles, probably by a covalent bond of silane to the surface of the fly ash particle and a polyethylene homopolymer or copolymer backbone to interact with the polyethylene resin via blending. Examples 1-7 show that these agents couple the fly ash particles to the resin, particularly as also seen in FIGS. 3, 4, and 5.

By comparison, Comparative Examples A, B, and S were controls of 100% thermoplastic resin which had better impact resistance than the Comparative Examples C, F, I, L, and T which had 15% of fly ash particles, the LLH7506 masterbatch and the LLH187506 masterbatch each having 75% of fly ash particles. FIG. 1 also offered visual proof. Comparative Examples D, E, G, H, J, K, and M-R all tried the use of maleated impact modifiers without success. FIG. 2 also offered visual proof. Comparative Examples U and V showed that an ungrafted ethylene-butene copolymer was also unsuccessful, by a comparison of both Notched Izod impact resistance and flexural modulus. The comparisons are Example 4 with Comparative Example V and Example 6 with Comparative Example U.

The −40° C. Notched Izod test results for Example 5 were entirely unexpected and an excellent demonstration of the versatility of that particular recipe among the others.

With the variations of recipes shown by Examples 1-9, a person having ordinary skill in the art without undue experimentation can adjust a number of factors such as type of coupling agent and amount of coupling agent to obtain a wide variety of physical properties as desired.

The invention is not limited to the above embodiments. The claims follow.

What is claimed is:

1. A thermoplastic compound, comprising:
(a) a thermoplastic resin
(b) particles of fly ash, and
(c) a coupling agent compatible with the thermoplastic resin comprising a grafted polymer having functional silane grafts on a backbone of a polymer same as the thermoplastic resin or a polymer compatible with the thermoplastic resin, wherein the fly ash is coupled to the coupling agent.

2. The compound of claim 1, wherein the thermoplastic resin and the polymer are selected from the group consisting of polyolefins, polyamides, polyesters, poly(meth)acrylates, polycarbonates, poly(vinyl halides), polyvinyl alcohols, polynitriles, polyacetals, polyimides, polyarylketones, polyetherketones, polyhydroxyalkanoates, polycaprolactones, polystyrenes, polyurethanes, polysulfones, polyphenylene oxides, polyphenylene sulfides, polyacetates, liquid crystal polymers, fluoropolymers, ionomeric polymers, and copolymers of any of them and combinations of any two or more of them.

3. The compound of claim 1, wherein the thermoplastic resin is an olefin and where the polymer is an olefin.

4. The compound of claim 3, wherein the thermoplastic resin is a polyethylene and wherein the coupling agent is a silane grafted polyethylene or a silane grafted alpha olefin copolymer.

5. The compound of claim 1, wherein the fly ash particles have a melting point or greater than about 1090° C.; a specific gravity of from about 2.2 to about 2.8; less than 100 parts per million of lead, hexavalent chromium, mercury or cadmium, a moisture content of 1% or less; a polycyclic aromatic hydrocarbon content of less than about 200 parts per million; a crystalline silica content of below about 0.5%; and a particle size range in which about 85% of the particles fall within 0.2 μm-280 μm, and remainder are less than about 850 μm.

6. The compound of claim 1, wherein the compound further comprises adhesion promoters; biocides, anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; or waxes; or combinations of them.

7. The compound of claim 1, wherein at least one coupled fly ash particle has cohesive failure before the fly ash particle and the coupling agent have adhesive failure.

8. The compound of claim 1, in the shape of a molded plastic article, an extruded plastic article, or a calendered plastic article.

9. A molded plastic article made from the compound of claim 1.

10. An extruded plastic article made from the compound of claim 1.

11. A calendered plastic article made from the compound of claim 1.
